(19) United States
(12) Patent Application Publication
(10) Pub. No.: US 2020/0196578 A1
(43) Pub. Date: Jun. 25, 2020

(54) FRAME FOR BEEHIVES

(71) Applicant: lb Carsten DALSGAARD, Kalundborg (DK)

(72) Inventor: lb Carsten DALSGAARD, Kalundborg (DK)

(21) Appl. No.: 16/485,311

(22) PCT Filed: Jan. 24, 2018
(86) PCT No.: PCT/DK2018/050012

§ 371 Date: Aug. 12, 2019

(30) Foreign Application Priority Data
Feb. 13, 2017 (DK) PA 2017 00103
Aug. 28, 2017 (DK) PA 2017 00468

(51) Int. Cl. A01K 47/02

(52) U.S. Cl. CPC A01K 47/02

(57) ABSTRACT

The invention relates to a frame for retaining a wax tablet in a beehive which frame comprises an upper list comprising a through slit, two side lists, and a lower list wherein the two side lists and/or the lower list includes retaining means that are suitable for guiding the wax tablet when inserted into the frame and suitable for stabilising the wax tablet after its insertion. The invention further relates to a beehive comprising one or more of the above frames.

This invention relates to a frame for retaining a wax tablet in a beehive which frame comprises an upper list comprising a through slit, two side lists, and a lower list.

The invention further relates to a beehive comprising one or more of the above-mentioned frames.

Most of the known frames for beehives are made of wood and are assembled by several pieces. The connections between the individual pieces make the wooden frames more susceptible to diseases. The wooden frames are not stable which means that they are deformed during use and especially during washing. Prefabricated wax tablets, which the bees can build on, are welded to the wooden frame in metal wires which either span from the top list (the upper list) to the bottom list (lower list) or span from the side list to side list. These metal wires become loose during washing. Therefore, a lot of time is used in the preparation of the wooden frames where the wax tablets are fixed. The welding procedure itself is slow and in addition, the wire must be tightened. Often, the wax tablet must be adapted to fit the wooden frame, and the spacing blocks (which ensure a distance between the individual frames in the beehive) may need to be adjusted. The durability of wooden frames is therefore not long.

There are different frames of plastic, but there is no one that is particularly widespread. There are plastic frames, which do not use wax tablets, but instead use plastic that is sprayed with a wax coating. These frames are, however, completely different from the frame according to the invention which uses wax tablets. There are plastic frames where the wax tablet must be snapped. Such a method is substantially different and slower than for the frame according to the invention. These frames also have moving parts which affects the durability of the frame adversely, and the frames are not cast into one piece.

US 2009/0227180 A1 tries to meet the above disadvantages by presenting a frame having a slit in the top list, bottom list and side lists. However, US 2009/0227180 A1, lacks wax control lists and frame stabilising lists (stabilising means) to stabilise the frame and to retain the wax tablet better.

Therefore, a frame is needed for a beehive in which it is easy to insert a wax tablet and which beehive has a stable structure that provides a long life.

According to the invention there is provided a frame for retaining a wax tablet in a beehive which frame comprises
an upper list comprising a through slit,
two side lists, and
a lower list,
wherein the two side lists and/or the lower list comprise retaining means that are suitable for guiding the wax tablet when it is inserted into the frame and suitable for stabilising the wax tablet after its insertion.

The frame saves the beekeeper a lot of time. The presence of a continuous slit in the upper list, as well as the retaining means, guides the wax tablet into position in the frame by insertion through the through slit in the upper list. Preparing and inserting a wax tablet into a frame can therefore be done in just a few seconds.

The structure of the frame implies that it does not change in shape by washing. The wax area is larger in the frame compared with existing frames (e.g. a wooden frame) thus providing a larger yield of honey when using the frame.

The use of a lower list, which also includes retaining means, implies that the wax tablet rests in the retaining means in the lower list (bottom list) after insertion of the wax tablet which helps retaining the wax tablet in place.

In an embodiment, the frame may further comprise stabilising means suitable for stabilising the structure of the frame and the structure of the wax tablet.

The use of stabilising means suitable for stabilising the structure of the frame and of the wax tablet implies that the structure of the frame and of the wax tablet is stabilised and additionally that the wax tablet is guided at the insertion into the frame.

In an embodiment, the stabilising means may comprise at least two elongated elements.

The two elongated elements can thus support/stabilise/retain the wax tablet and thus also guide both sides/surfaces of the wax tablet both during and after the insertion of the wax tablet into the frame. In addition, the stabilising means (the elongated elements) can support the wax tablet when extracting honey.

In an embodiment, each of the elongated elements can be connected to and extend between at least two of said upper lists, side lists, and lower lists.

Thereby, the elongated elements can contribute to the stability of the frame as the elongated elements retain the position of said lists relative to each other.

In an embodiment, the elongated elements can extend between said upper list and at least one of said two side lists.

This prevents the upper, side and lower lists of the frame from twisting. In addition, the elongated elements help to insert and retain the wax tablet.

In an embodiment, the elongated elements can extend between said lower list and at least one of said two side lists.

This prevents the upper, side, and lower lists of the frame from twisting. In addition, the extensive elements help to insert and retain the wax tablet.

In an embodiment, the elongated elements can be displaced relative to each other in the plane of the frame.

This prevents that the elongated elements are connected to the same cells in the wax tablet (so that cocoon and other residues from the bees cannot get stuck between them) which could complicate the removal of the wax tablet after use. However, it is envisaged that said elongated elements can be positioned opposite each other relative to the plane of the frame (i.e. the plane in which said upper, side, and lower lists extend and thus define).

In an embodiment, the elongated elements can be lists.

The inventors have found that the elongated elements can be preferably lists, thereby ensuring that a flat surface on the elongated elements is in contact with the wax tablets thus providing better stabilisation and guidance for the wax tablets.

However, it is also foreseen that the elongated elements and the upper, sider and lower lists of the frame can have a circular, oval, multilateral or other cross section.

In an embodiment, the retaining means can comprise an elongated depression.

It is known that an elongated depression can provide an effective and stable retention of an object such as a plate or tablet.

In an embodiment, the outer edges of the elongated depression can be rounded.

Thus, the outer edges of the depressions can have tolerance rounds. Because the outer edges of the depressions can be rounded, the frame is stabilised to ensure better retention of the wax tablet and larger fluctuations can be allowed in the tolerance of the wax tablet.

In an embodiment, the elongated depression can be formed as a groove in said side lists and/or lower list.

Because said depression can be formed as a groove/slit in said side lists and/or lower list, the area of the wax tablet, which the bees can use, is maximised. In addition, the depression can be visually less evident.

In an embodiment, said recess can be formed of two contiguous elongated protrusions on said side lists and/or lower list.

Thereby the thickness/width of the upper, side, and bottom lists of the frame (relative to the plane of the frame) can be minimised and thus, the amount of material for making the frame and the weight of the frame can be minimised.

In an embodiment, the frame can be formed in one piece.

Since the frame can be formed in one piece, there are no connections in the frame and thus, there are fewer suitable places where bacteria can live and where they are difficult to remove (less chance of bacteria getting settled). This minimises the risk of disease among the bees. In addition, the structure of the frame is improved/stabilised when it is formed in one piece. Further, it has been found that the bees build more uniformly on the frame according to the invention and therefore, it is easier and faster to get the sealing off before the honey is extracted from the frames.

In an embodiment, the frame can comprise spacers.

The spacers/spacer blocks can be located on the sides of the side lists and/or the upper list (i.e. perpendicular to the plane of the frame). Thus, the spacers/spacer blocks can ensure that the distance to the neighbour frames in the beehive is maintained. Because the frame is narrow (perpendicular to the plane of the frame), the spacer blocks are longer than normal, so the bees cannot glue the frames together. The long spacer blocks also make the frames more stable. The spacer blocks can thus extend at least partially along the lengths of the side lists. The spacer blocks can thus extend at least ⅓ or ½ of the lengths of the side lists.

In an embodiment, the frame can comprise a carrier list. The carrier list can be located at each end of the upper list. The carrier list can be used to hold/carry the frame in the beehive. The spacer blocks can be in extension of the carrier lists perpendicular to the plane of the frame.

In an embodiment, the frame can comprise a plastic material.

The use of a frame made of plastic material (e.g. moulded in plastic) has the advantage that the frame cannot soak moisture thus minimising the risk of the presence of mould.

In addition, plastic materials can withstand the heat levels that the frames are exposed to during washing (e.g. mechanical cleaning) so that they do not deform. The plastic can also withstand the acids used to combat varroa mites. The plastic and the actual construction of the frame make it hold the shape for many years.

In an embodiment, a frame can be provided moulded in plastic for beehives which frame can have a top list (upper list) having a carrier list and a through slit adapted to allow a wax tablet to be inserted into the frame through said slit; and which frame can have side lists and bottom list (lower list) having inner slits (securing means) in which a wax tablet can be retained, wherein the frame can be equipped with wax guiding and frame stabilising lists (stabilising means) that can be placed between the top list and the bottom lists, two on each side of the slit in the top list. The lists can be in offset positions.

The frame can have tolerance roundings on the inside of all slits thus making the slits deeper and holding the wax tablet in place, even though it varies slightly in width.

According to the invention there is further provided a beehive comprising one or more frames according to the above mentioned.

The structure and function of the frame will be described in more detail below, referring to embodiments shown in the figures.

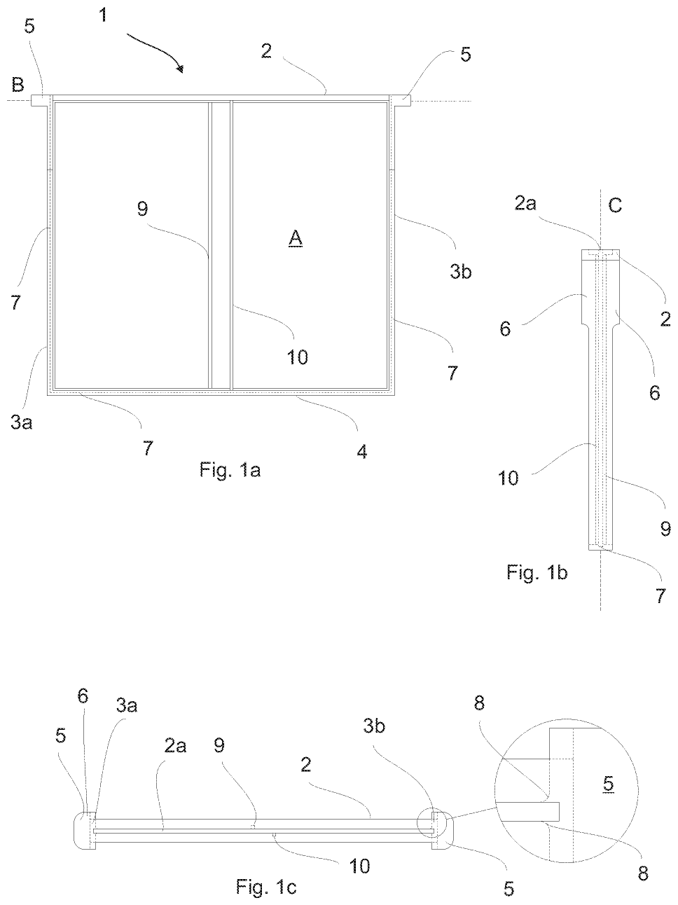

FIGS. 1a, 1b, and 1c show an embodiment of a frame for a beehive shown from three directions.

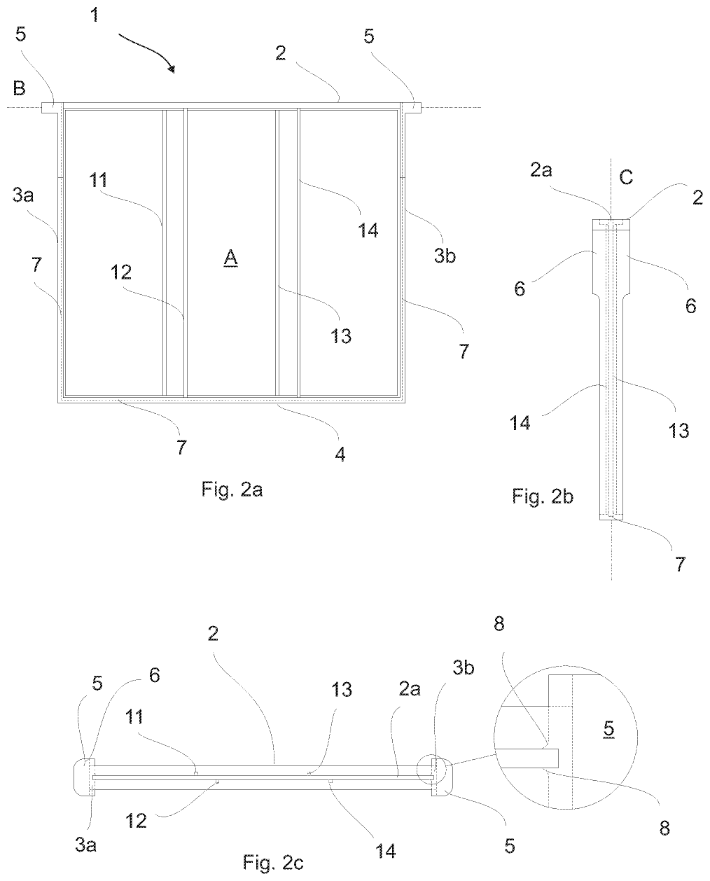

FIGS. 2a, 2b, and 2c further illustrate an embodiment of a frame for a beehive shown from three directions.

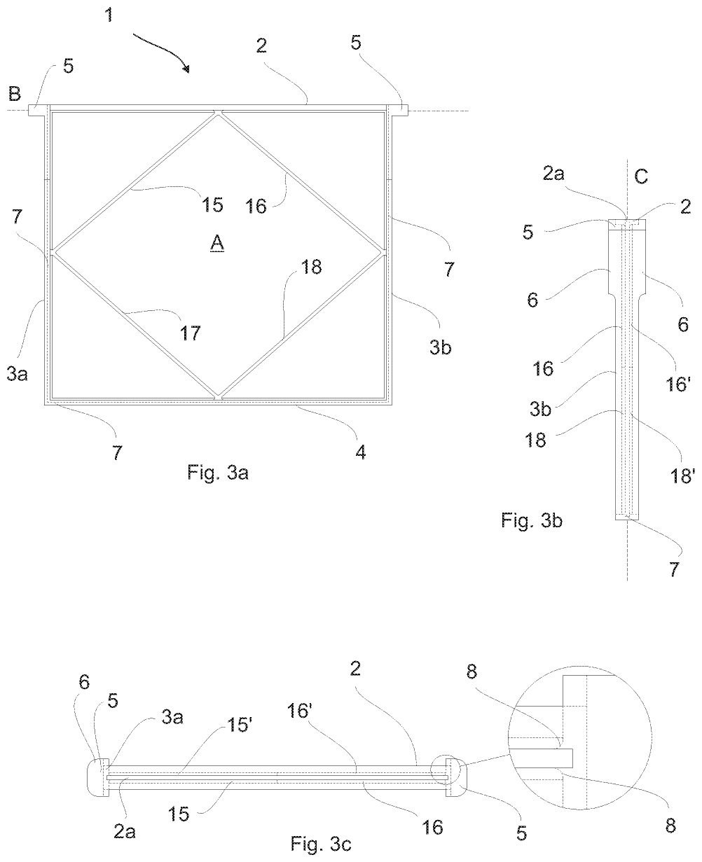

FIGS. 3a, 3b, and 3c further illustrate an embodiment of a frame for a beehive shown from three directions.

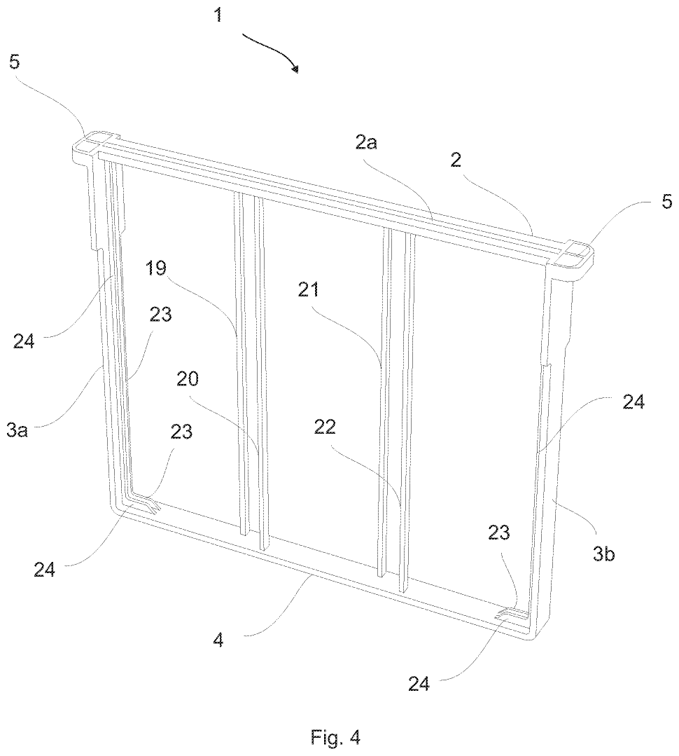

FIG. 4 further shows an embodiment of a frame to a beehive in a perspective view.

FIGS. 1a, 1b, and 1c show an embodiment of a frame fora beehive.

The frame 1 comprises an upper list 2, a first 3a and a second side list 3b, and a lower list 4 which define the plane A of the frame collectively. In the embodiment shown in FIG. 1, one end of each of the two side lists 3a, 3b is connected to each end of the upper list 2, and one end of each of the two side lists 3a, 3b is connected to each end of the lower list 4.

The upper list 2 can further comprise a carrier list 5 which can be located in conjunction with (in continuation of) the two ends of the upper list 2, and which can be used to hold/carry the frame 1 in the beehive.

The upper list 2 comprises a through slit 2a which can extend completely or partially in the length of the upper list 2 and along the longitudinal axis B of the upper list 2. A wax tablet can thus be inserted into the frame 1 via said through slit 2a.

The frame 1 can further comprise spacers 6 which can be located on the sides of the first 3a and second side list 3b and/or carrier list 5 (relative to the plane of the frame A and to the longitudinal axis C of the side lists). The spacers/spacer blocks 6 can thus ensure that the distance to the neighbouring frames 1 is maintained.

The first 3a and second side lists 3b and/or the lower list 4 comprises retention means 7 which guide the wax tablet when it is inserted and cause the wax tablet to rest in the retention means 7 subsequently thus helping the wax tablet keeping in place. In FIGS. 1a, 1b, and 1c, the retention means 7 are shown to be an elongated depression formed as a groove in said first 3a and second side list 3b and lower list 4 and extending in the entire length of said first 3a and second side lists 3b and lower list 4. However, as mentioned above, it is foreseen that the elongated groove can extend in only a portion of said lengths.

In FIG. 1c, it is shown that the outer edges of said elongated depression can have roundings 8 (be rounded). Thus, the outer edges of the depressions can have tolerance roundings 8. Because the outer edges of the depressions can be rounded, the frame 1 is stabilised thus ensuring better retaining of the wax tablet and allowing greater fluctuations in the tolerance of the wax tablet.

Stabilising means, which are shown in FIGS. 1a, 1b, and 1c as two elongated elements 9, 10, support/stabilise/retain the wax tablet and thereby guide both sides/surfaces of the wax tablet both during and after insertion in frame 1. In addition, the stabilising means (the elongated elements 9,10) can support the wax tablet when extracting honey.

In FIGS. 1a, 1b, and 1c, the elongated elements 9,10 are shown to be connected to and extend between the upper 2 and the lower list 4, i.e. parallel to the direction into which the vax tablet is introduced. Thereby, the elongated elements 9, 10 can contribute to the stability of frame 1 as the elongated elements 9, 10 retain the position of said lists 2,4 in relation to each other.

In FIGS. 1a, 1b, and 1c, it is shown by way of example that the two elongated elements 9, 10 are displaced relative to each other in the plane of the frame as this prevents said extended elements 9,10 from being connected to the same cells in the wax tablet which can otherwise make it difficult to remove the wax tablet after use. However, it is envisaged that said elongated elements 9, 10 can be positioned opposite each other relative to the plane of the frame 1.

FIGS. 2a, 2b, and 2c further illustrate an embodiment of a frame 1 for a beehive.

For similar elements as shown in FIGS. 1a, 1b, and 1c, similar reference numbers are used.

In the embodiment shown in FIGS. 2a, 2b, and 2c, the frame 1 comprises stabilising means in the form of four elongated elements 11, 12, 13, 14 which support/retain the wax tablet and thus guide both sides/surfaces of the wax tablet both during and after insertion into the frame. In addition, the stabilising means (the elongated elements 11, 12, 13, 14) can support the wax tablet when extracting honey.

In FIGS. 2a, 2b, and 2c, the elongated elements 11, 12, 13, 14 are shown to be connected to and extend between the upper 2 and the lower list 4, i.e. parallel to the direction into which the vax tablet is introduced. Thus, the elongated members 11, 12, 13, 14 contribute to the stability of frame 1 as the elongated members 11, 12, 13, 14 retain the position of said lists 2, 4 relative to each other. The elongated members 11, 12, 13, 14 are shown to be displaced relative to each other in the plane of the frame 1.

FIGS. 3a, 3b, and 3c further illustrate an embodiment of a frame 1 for a beehive.

For similar elements as shown in FIGS. 1a-c and 2a-c, similar reference numbers are used.

In the embodiment shown in FIGS. 3a, 3b, and 3c, the frame 1 comprises stabilising means in the form of four elongated members 15, 15′, 16, 16′, 17, 17′, 18, 18′ on each side of the retaining means 7 which support/stabilise/retain the wax tablet and thus guide both sides/surfaces of the wax tablet both during and after insertion into the frame 1. In addition, the stabilising means (the elongated elements 15, 15′, 16, 16′, 17, 17′, 18, 18′) can support the wax tablet when extracting honey.

In FIGS. 3a, 3b, and 3c, the elongated members 15, 15′, 16, 16′, 17, 17′, 18, 18′ are shown to be connected to and extend between the upper 2 and the first 3a or second side list 3b, or between the lower 4 and the first 3a or other side list 3b, i.e. with an angle relative to the direction into which the vax tablet is inserted. Thereby, the elongated members 15, 15′, 16, 16′, 17, 17′, 18, 18′ can contribute to the stability of the frame 1 as the elongated members 15, 15′, 16, 16′, 17, 17′, 18, 18′ retain the position of said lists 2, 3a, 3b, 4 in relation to each other. Additionally, it may be prevented that the upper 2, the side 3a, 3b and the lower lists 4 of the frame can be twisted.

In FIGS. 3a, 3b, and 3c, it is shown that the elongated members 15, 15′, 16, 16′, 17, 17′, 18, 18′ are connected to the centre of the upper list 2 and/or the lower list 4 and/or the first 3a or the second list 3b. However, it is anticipated that said elements 15, 15′, 16, 16′, 17, 17′, 18, 18′ can alternatively be connected to said lists 2, 3a, 3b, 4 at a position offset to the middle of said lists 2, 3a, 3b, 4.

FIG. 4 further shows an embodiment of a frame 1 for a beehive.

For similar elements as shown in FIGS. 1a-c, 2a-c and 3a-c, similar reference numbers are used.

In FIG. 4, the frame 1 comprises stabilising means in the form of four elongated elements 19, 20, 21, 22 which support/stabilise/retain the wax tablet and thus guide both sides/surfaces of the wax tablet both during and after insertion into the frame 1. In addition, the stabilising means (the elongated elements 19, 20, 21, 22) support the wax tablet when extracting honey.

In FIG. 4, the elongated elements 19, 20, 21, 22 are shown to be connected to and extend between the upper 2 and the lower list 4, i.e. parallel to the direction into which the wax tablet is inserted. Thus, the elongated members 19, 20, 21, 22 can contribute to the stability of frame 1 as the elongated members 19, 20, 21, 22 retain the position of said lists 2, 4 relative to each other. The elongated members 19, 20, 21, 22 are shown to be displaced relative to each other in the plane of frame 1.

In FIG. 4, the depression is shown to be formed by two parallel elongated projections 23, 24 on the first 3a and the second side list 3b and the lower list 4. In this way, the thickness of the side lists 3a, 3b and lower list 4 of the frame 1 can be minimised (relative to the plane of frame 1) and thus, the amount of material for the manufacture of the frame 1 and the weight of the frame 1 can be minimised. In the embodiment shown in FIG. 4, it is further shown that said elongated protrusions 23, 24 can run throughout the lengths of the first 3a and the second side lists 3b, but only partially in the length of the lower list 4.

1. A frame for retaining a wax tablet in a beehive which frame comprises
an upper list comprising a through slit,
two side lists, and
a lower list,
wherein:
the two side lists and/or the lower list comprises retaining means that are suitable for guiding the wax tablet when it is inserted into the frame and suitable for stabilising the wax tablet after its insertion, and wherein the frame further comprises stabilizing means suitable for stabilizing the structure of the frame and wax tablet, said stabilizing means comprising at least two elongated elements.

2. (canceled)

3. (canceled)

4. The frame according to claim 1, wherein each of the elongated elements is connected to and extends between at least two of said upper, side and lower lists.

5. A frame according to claim 1, wherein the elongated elements extend between said upper list and at least one of said two side lists.

6. A frame according to claim 1, wherein the elongated elements extend between said lower list and at least one of said two side lists.

7. A frame according to claim 1, wherein the elongated elements are lists.

8. A frame according to claim 1, wherein the retaining means comprise an elongated depression.

9. The frame according to claim 6, wherein the outer edges of the elongated depression are rounded.

10. A frame according to claim 8, wherein the elongated depression is formed as a groove in said side lists and/or lower list.

11. A frame according to claim 8, wherein said depression is formed by two contiguous elongated protrusions on said side lists and/or lower list.

12. A frame according to claim 1, wherein the frame is formed in one piece.

13. A frame according to claim 1, wherein the frame comprises spacers.

14. A frame according to claim 1, wherein the frame comprises a plastic material.

15. A beehive comprising one or more frames according to claim 1.

16. A beehive comprising one or more frames according to claim 14.

17. A frame according to claim 1, wherein the retaining means extend partially along the length of the lower list and/or side lists.

18. A frame for retaining a wax tablet in a beehive, which frame comprises an upper list comprising a through slit, two side lists, and a lower list, wherein the frame further comprises stabilising means suitable for stabilising the structure of the frame and wax tablet, said stabilising means comprising at least two elongated elements preferably being connected to and extending between at least two of said upper, side and lower lists.
